(19) United States
(12) Patent Application Publication
(10) Pub. No.: US 2006/0179472 A1
(43) Pub. Date: Aug. 10, 2006

(54) System and method for effectuating computer network usage

(76) Inventors: Ifan Chang, Flushing, NY (US); Tolga Ergunay, New York, NY (US); Ding-Hou Lee, Palisades Park, NJ (US)

Correspondence Address: KAYE SCHOLER LLP, 425 PARK AVENUE, NEW YORK, NY, 10022-3598, US

(21) Appl. No.: 11/323,082

(22) Filed: Dec. 30, 2005

Related U.S. Application Data
(60) Provisional application No. 60/640,886, filed on Dec. 30, 2004.

(51) Int. Cl. H04L 9/32

(52) U.S. Cl. 726/2

(57) ABSTRACT

In one example of an embodiment of the invention, a method to control usage of resources on a network by an entity comprising a user and a host device to couple the user to the network is disclosed, comprising receiving identification information from the entity, evaluating the identity of user, and evaluating the host device. In addition, the method comprises evaluating a status of at least one additional condition related to the user and allowing the entity to use one or more network resources based, at least in part, on the evaluations. Conditions may be aggregated from a plurality of network resources. Any of these activities may be performed by plug-ins.

The present application claims the benefit of U.S. Provisional Patent Application No. 60/640,886, which was filed on Dec. 30, 2004 and is incorporated by reference herein.

### FIELD OF INVENTION

The invention relates to computer systems and methods, and, more particularly to a system and method for managing host access to computer networks.

### BACKGROUND OF INVENTION

As the capability for computers to communicate with one another continues to increase, the availability of computer networks is becoming more and more ubiquitous. For example, most employees have access to workplace computer networks and most students have access to university computer networks—in the form of a local area network (LAN), wide area network (WAN), or the like. Moreover, such employees and students, as well as other users, have access to the World Wide Web, the Internet, and other publicly available networks.

Users can access these networks through multiple media, including a wireline connection, wireless connection, or a combination of the two. Moreover, users can access networks in an increasing number of places. For example, hotels, restaurants, cafes, and libraries are just a few of the venues that enable users to access networks, such as the Internet, through wireless and/or wireline connections, using their own computers, personal digital assistants (PDAs), etc.

As the number of networks and access thereto continue to rise, it is becoming increasingly important that network access providers monitor for and control which users connect to their systems and the scope of access these users are given to resources that are available through the network.

In many existing networks, a designated server, referred to as a gateway server, receives network access requests from users and controls the users' access to the network. A gateway server may also monitor the activities of users on the network and prevent a user from accessing a resource that the user is not authorized to access. In some networks, a gateway server may simply receive a user identifier (user ID) and compare the identifier against a list of authorized user IDs to determine whether or not the user is authorized to access the network. In other systems, a gateway server may connect a user attempting to access a particular network resource to the user's desired destination, which may be a device such as an email server, an internet server, etc., that is connected to the network. These other devices typically are responsible for determining whether or not the user is authorized to access the desired network resource, and deny the user access if the user is not authorized.

### SUMMARY OF THE INVENTION

Methods and systems are provided for controlling usage of network resources in a network. In one example, the network comprises a local area network (LAN) maintained, for example, by a university, a corporation, or other such organization. The network may comprise a device such as a gateway server that receives and collects information and controls usage in the network by users and/or hosts. Thus, in one embodiment of the invention, identification information is received from an entity, which may comprise a user and/or a host device, for example. Information pertaining to the entity is obtained from one or more processors in the network. The processors may comprise one or more servers, for example, which are associated with network resources, such as email, a library, access to the Internet, etc.. The information received from the processors is aggregated to generate a set of usage rules, and the entity is allowed to use the network resources in accordance with the set of usage rules. Control over network usage may be dynamic. For example, additional information may be received while the entity uses the one or more network resources. The set of usage rules is updated based on the additional information, and the entity is allowed to use one or more network resources in accordance with the updated set of usage rules. The usage rules may be implemented through at least one plug-in.

In a related embodiment, a system to control use of a network is disclosed comprising a first processor, a network, and a plurality of second processors coupled to the network. The first processor is configured to receive from an entity identification information, transmit the identification information to the plurality of second processors, receive from at least some of the second processors usage information pertaining to the entity, the usage information comprising at least one condition, aggregate the received usage information to generate a set of usage rules, and allow the entity to use the network in accordance with the one or more usage rules. The first processor may comprise at least one plug-in to determine whether to allow the entity to use the network in accordance with the usage rules. The first processor may also comprise at least on plug-in to aggregate the received usage information to generate the set of usage rules.

In accordance with another embodiment of the invention, a method to control usage of resources on a network by an entity comprising a user and a host device to couple the user to the network is disclosed, comprising receiving identification information from the entity, evaluating the identity of user, and evaluating the host device. In addition, the method comprises evaluating a status of at least one additional condition related to the user and allowing the entity to use one or more network resources based, at least in part, on the evaluations. Evaluating the user may comprise authenticating the user. Authenticating the user may comprise implementing a plurality of authentication procedures by a respective plurality of plug-ins. Evaluating the host device may be implemented by at least one plug-in. Host evaluation may comprise determining whether the host device is vulnerable or infected. Evaluating the status may comprise determining whether there is a temporal limitation on an activity of the user with respect to the network and determining the current time. The evaluations may be changed by changing at least one plug-in. An evaluation may be added by adding at least one plug-in. A plug-in may be persistent. Additional conditions may be aggregated from at least two respective network resources, which may also be implemented by a plug-in.

In accordance with a related embodiment, a system to control usage of resources on a network by an entity comprising a user and a host device to couple the user to the network is disclosed comprising a processor and network The processor is configured to evaluate the identity of the user, evaluate the host device, evaluate at least one additional condition related to the user, and allow the user to use one or more network resources based, at least in part, on the evaluations. Plug-ins may be used to implement any or all of these activities.

### BRIEF DESCRIPTION OF DRAWINGS

FIG. 1 is a block diagram of an example of a communications system, in accordance with an embodiment of the invention;

FIG. 2A is a flowchart of an example of a method to control usage of one or more network resources by a user and/or a host, in accordance with an embodiment of the invention;

FIG. 2B is a flowchart of a more detailed example of a method to control usage of one or more network resources by a user and/or a host, in accordance with an embodiment of the invention;

FIG. 3 is an example of an access rules database, in accordance with an embodiment of the invention;

FIG. 4 is a block diagram of an example of computer system, in accordance with another embodiment of the invention;

FIG. 5 is an example of a block diagram of a gateway server provided in the system of FIG. 1, in accordance with an embodiment of the invention;

FIG. 6 is a flowchart of an example of a method for enabling users/hosts to connect to the system of FIG. 4, in accordance with an embodiment of the invention;

FIG. 7 is a table of representative connection status codes and related descriptions provided by the system of FIG. 4, in accordance with an embodiment of the invention;

FIG. 8 is a flowchart of an example of a method of terminating a user/host's connection to the system of FIG. 4, in accordance with an embodiment of the invention;

FIG. 9 is a flowchart of an example of access and resource options available to users/hosts connecting to the system of FIG. 4, in accordance with an embodiment of the invention;

FIG. 10 is a table of representative access status codes and related descriptions provided by the system of FIG. 4, in accordance with an embodiment of the invention; and

FIG. 11 is a block diagram of an example of multiple gateway servers in communication with each other, in accordance with an embodiment of the invention.

### DETAILED DESCRIPTION OF THE PREFERRED EMBODIMENTS

In an example of an embodiment of the invention, methods and systems are provided for controlling usage of network resources within a network. When an entity, which may comprise a user and/or a host device, for example, accesses a network in order to use a desired network resource, a gateway server receives usage-related information from a plurality of the network resources and aggregates the information to create a set of usage rules for the entity. Examples of network resources include email, the Internet, and a library, for example. The set of usage rules may comprise one or more categories or “layers” of rules pertaining to different aspects of the entity's activities within the network. One example of multiple layers of usage rules that may be provided are authentication rules, which govern the entity's authorization to access the network, and access rules, which govern the entity's ability to access specific network resources. Access rules may include conditions on access, including temporal conditions, for example. For example, a user's access to the network and/or the particular resources may be limited by the time of the day. A host device's access to the network and/or network resources may also be limited by the device's characteristics, such as whether the device is infected by a virus, for example. The multiple authentication and access rules provide multiple authentication layers.

Another example of a layer of usage rules are operational rules, which govern the operation of various network resources by the entity. For example, one or more operational rules may control aspects of the operation of a host computer, such as the type of material may be downloaded, the operation of a printer, such as the type of material that may be printed, or the operation of an exercise machine, to optimize the machine's health benefits for the particular user or for safety. Other types of rules may be provided, as well.

In accordance with one embodiment, software plug-ins are used to implement some or all of the operations of the system, including user authentication, host evaluation, and/or usage rule application. A “plug-in” as used herein, is a software module that performs processing to achieve discrete goals, such as authentication, virus check, or determining whether an entity should have access to a particular network resource and under what conditions, for example. The plug-ins are preferably provided on a gateway server that controls the usage of the network by the entity. Each software plug-in may be dedicated to a particular usage rule, for example. The use of plug-ins facilitates the addition of new authentication procedures, usage rules, and system resources, as well as changes thereto. The “plug-in” capability also facilitates operation of a network with multiple usage rules, categories or “layers” of rules governing different aspects of a user's or host's access and actions within the network.

In one example, when a user attempts to access a network via a host device in order to access one or more network resources, a gateway server receives identification information from the user and from the host device. The gateway server authenticates the user and evaluates the host device for virus and the like. If the user is authenticated and the device found to be acceptable, the gateway then communicates with a plurality of servers within the network associated with network resources and receives from each of those servers usage information pertaining to the user and/or the host. The usage information may include at least one condition on the user's or host device's access to a network resource, or their operation of the network resource, for example. The gateway server aggregates the received usage information to generate a set of usage rules for the user and host. The gateway server then applies the set of usage rules to determine one or more usage rights for the user and host, and allows the user and host to access and use the network accordingly. Usage rights may be time dependent or be dependent on other conditions, for example.

It should be noted that discussions herein that pertain to system connection and user/host authentication relate to whether a user and/or host is permitted to take advantage of any resources made available by a network, whereas discussions pertaining to system access refer to the specific system resource(s) the user may access.

In accordance with an embodiment of the invention, a network access provider may dynamically evaluate usage rules, such as access and operational rules, to determine whether one or more hosts/users that are already connected and are conducting activities, can continue to be connected and conduct the same or other activities. A network access provider may dynamically and precisely determine which users are allowed to connect to a network that is under the provider's control as well as the resource access that is given to those users who successfully connect to the network. User connectivity and access may be modified in a manner that may (1) affect all users, a class of users, or a specific user; (2) provide for flexible temporal limitations associated with the modifications (they may be made in real-time or near real-time, at a pre-designated time, indefinitely, temporarily, etc.); and/or (3) enable modifications based upon user identification, user status (students, salesmen, etc.), equipment (or host) identification or status, or user/host activities.

In one application, a university may configure its computer network, which may comprise multiple servers controlling access to various network resources, such as Internet access, university email accounts, library resources, etc., to monitor and control students' access to the various resources. When a student logs onto the network via a host computer, for example, a gateway server may evaluate the user by one or more authentication processes and evaluate the host by conducting a virus scan, for example. If the user is authenticated and the host computer is found to be acceptable, the gateway may communicate with various servers within the network and generate an aggregated set of rules to control the student's access to various network resources. For example, the aggregated set of rules may specify that if the student attempts to log in to the university's computer system while the student is scheduled to be in class, the student's authentication may be denied and connectivity is terminated, or the system resources available to that student (and other students in the same class) may be limited. If a user connects prior to the start of class but continues their connection when class starts, the connection may be terminated. If a user is only allowed limited access during class, the access may be increased after the time when the class ends. If a network resource changes a usage rule while a student is connected, the student's usage rights may change, and the student may be disconnected or their operations limited, as well. Such conditions, as well as the evaluations of the user and the host, are readily implemented by plug-ins in the gateway server, for example.

In another application, within a corporate office, a computer network may comprise multiple servers controlling access to various network resources, such as Internet access, company-maintained email accounts, company documents, etc., to monitor and control employees' access to and operation of the various resources. When an employee logs onto the network via a host computer, the employee is authenticated and the host computer evaluated, as above. If that is successful, a gateway server may then communicate with various servers within the network and generate an aggregated set of usage rules.

For example, a corporate network may be configured such that employees cannot access all of the resources of their office computer network when they are scheduled to attend a mandatory meeting. Thus, the corporate office's computer system may be configured such that, in general, all employees typically have access to all system resources (except, for example, sensitive accounting and security applications). However, if a mandatory meeting is scheduled for the corporate sales force during a given time period each month (the first Monday of the month, from 9:00 a.m. to 1:00 p.m., for example), it may be desirable, for this time period only, to terminate access to certain system resources (such as Internet connectivity and Lotus Notes) by the sales force, to encourage meeting attendance, but to maintain, for example, printer access in case a salesperson needs to print materials for or during the meeting.

In addition, it may be desirable to restrict Internet access by those employees (salesperson or any other employee) who have been downloading unauthorized or inappropriate materials from the Internet. It may also be desirable to restrict access to the network by host computers that do not have the most up to date browser software or virus protection software, and/or computers that have unauthorized software applications, such as unauthorized packet sniffer applications, for example. In addition, a host computer's access to the network may be terminated if the host computer becomes infected with a virus while connected to the network. By storing the conditions for restricting user/host access, storing conditions for completely terminating user/host activity, and storing user/host information, the computer system is capable of determining access and operational rights for each user and is capable of implementing the rights. As above, the evaluations of the user and host, and application of the conditions, may be readily implemented via plug-ins.

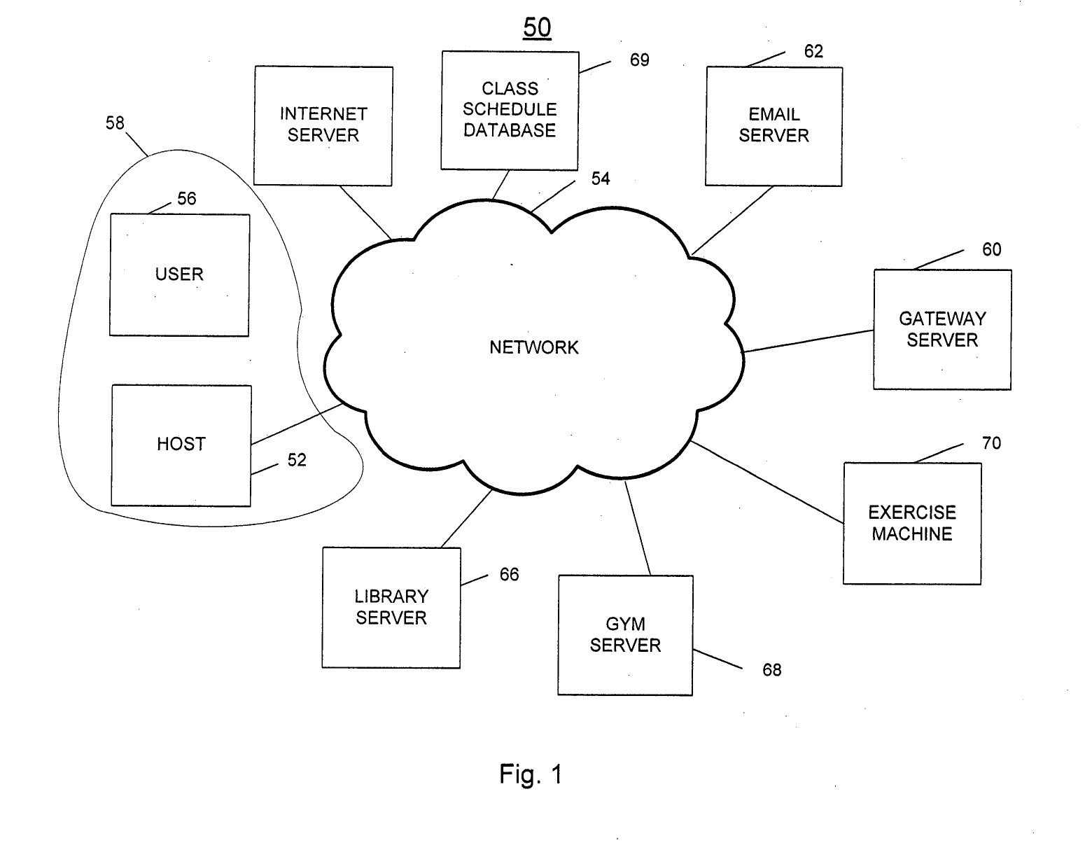

FIG. 1 is a block diagram of an example of a communications system 50, in accordance with an embodiment of the invention. The system 50 comprises one or more host devices 52 coupled to a network 54. Only one such host device 52 is shown in FIG. 1. A user 58, who may be a person, accesses network and the resources available on the network, through the host device 52. Together, the user 58 and the host device 52 are referred to as an entity 58. Also connected to the network 54 is a gateway server 56 and one or more additional processors, such as a email server 62, an Internet server 64, a library server 66, and a gym server 68, for example, which control the use of respective network resources, including the access to the respective resource. A class schedule database 69 is also coupled to the network 54.

All components coupled to the network, including the gateway server 60, the servers 62, 64, 66, 68, and the database 69, may be coupled to the network through wired connections or wirelessly. A wide variety of other types of devices may also be coupled to the network 54. As an example, an exercise machine 66 is shown connected to the network 54 and to the gym server 64 in FIG. 1. Another example of a device that may be coupled to the network 54 and whose operations may be subject to conditions is the host 52 itself. For example, the host 52 may be a computer in a library, which can only download certain types of library materials. A printer (not shown) may also be coupled to the network 54 and its operations may be subject to the limitations on the type of material that may be printed. For example, the printing of copyrighted material may be limited. As above, the usage rules are preferably implemented by plug-ins on the gateway server 60.

The network 54 may comprise any one of a number of different types of networks. The network 54 may be, for example, an intranet, a local area network (LAN), a wide area network (WAN), an Internet, Fibre Channel storage area network (SAN), or Ethernet. Alternatively, the network 54 may comprise a combination of different types of networks. Communications may be conducted over the network 54 by means of IP protocols. In another example, communications may be conducted over network 54 by means of Fibre Channel protocols.

The host 52 may comprise one or more computers or other devices, such as one or more personal computers (PCs) servers, workstations, cell phones, personal digital assistants (PDAs), etc. Alternatively, the host 52 may comprise a software application residing on a computer or other device. The host may be wirelessly coupled to the network, or may be coupled to the network by a wired connection.

In an illustrative example, the network 54 may connect various servers, personal computers and other devices across a university campus. The host 910 may comprise a PC located in a library on a university campus, for example.

Each network resource may have a set of conditions for controlling access and use of the resource. The conditions may be stored on the server associated with the respective network resource. In the illustrative example, the Internet server 64 controls access by users and hosts at a university to the Internet. Thus, the Internet server 64 comprises a database of conditions on the use of the Internet by university students and/or employees. Conditions may relate to specific allowed and/or disallowed websites and/or temporal limitations on when the Internet or specific websites may be accessed, for example. Based on those conditions, the gateway server 60 establishes a connection between a host, such as the host 52, and the Internet, if access is granted, or denies or terminates such a connection if access is denied. In one such condition, access is denied to particular students or to an entire class during scheduled class times and/or during a scheduled exam, for example. Certain hosts on the university campus may also have conditions on their use of the Internet. For example, access to the Internet may be denied to computers in the university library, such as host 52.

Also, in this example, the email server 62 controls access by students and faculty to their university-maintained email accounts. The email server 62 generally allows unrestricted access to university email accounts; however, if requested by a faculty member, one or more students may be denied access to the university email accounts during scheduled class times and/or during a scheduled exam.

Also, in this example, the library server 66 controls access by students and faculty to online university library resources. In accordance with the policies of the library server 66, students generally have unrestricted access to the university's online library resources. However, computers located in the university library, including host 52, are only allowed to download textual material and are restricted from downloading any video materials.

Any number of network resources may be accessible via the network 50. For example, a physics professor may wish to make available particular resources, such as the current readings of a relevant laboratory device to a class of physics students. For this purpose, the physics professor may post the laboratory device's current measurements on a customized website maintained by the physics department and provide authorization to access the website only to students in the class. The system 50 may further restrict access to the information to class times only. The information may also be available at a particular website on the Internet and access to this particular website may be enabled, even if other access to the Internet is not allowed during class time. If the student attempts to connect to another website, the student may be redirected back to the allowable physics website, or an error message may be displayed, for example. In another example, a university history department may wish to allow access to the history department's server only to those students majoring in history.

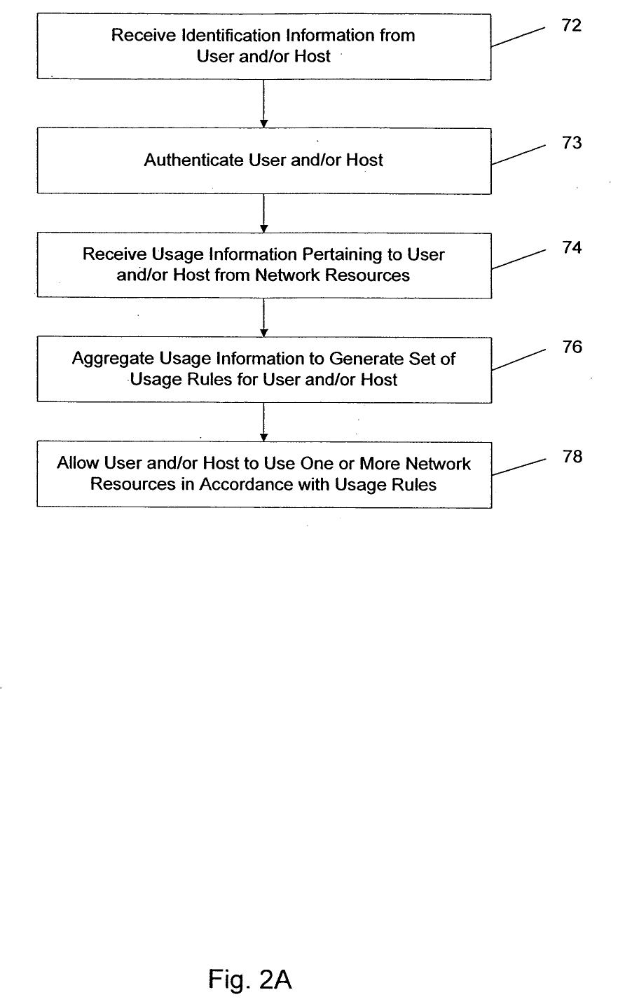

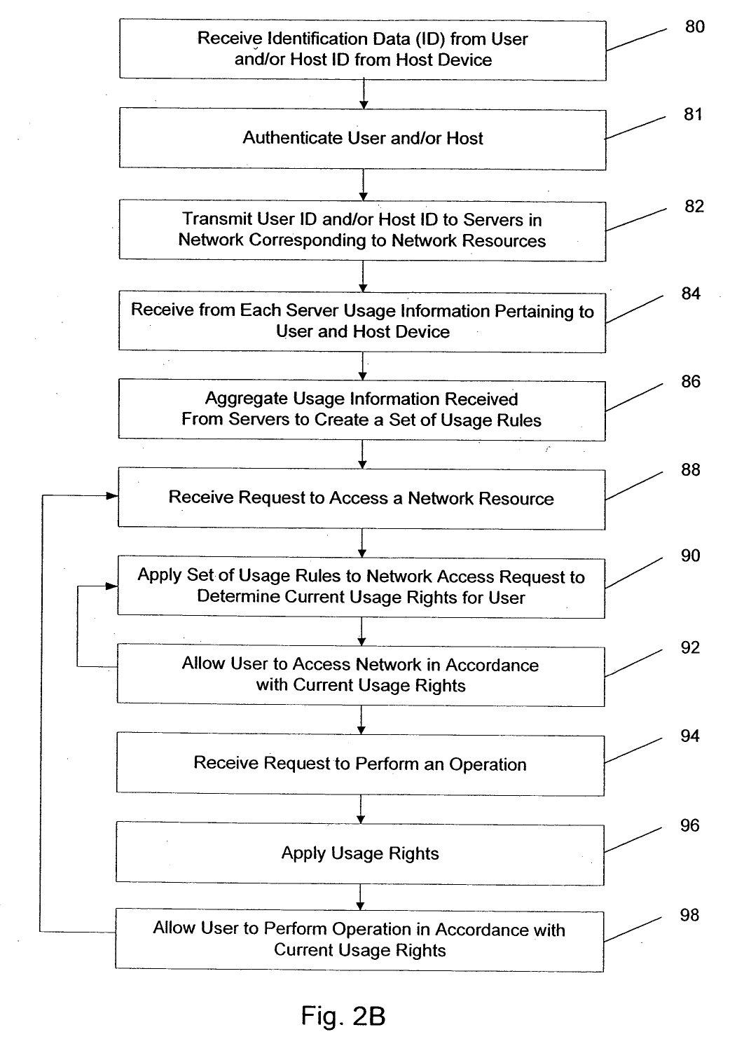

In accordance with an embodiment of the invention, the gateway server 925 receives and aggregates usage information from one or more processors within the system 50 and establishes a set of usage rules governing a user's access and operation of network resources based on the aggregated information. The gateway server 60 then enables the user 56 and/or host 52 to use one or more network resources based on the set of usage rules. FIG. 2A is a flowchart of an example of a method for controlling usage of one or more network resources, in accordance with this embodiment of the invention. At step 72, identification information is received from a user 56 and/or a host computer 52. At step 73 the gateway server 60 authenticates the user 56 and/or host 52. Authentication may take place in an ordinary manner. Preferably, however, a multilayer authentication process is performed to authenticate the user 56 and the host 52. Examples of authentication techniques include Active Directory, available from Microsoft Corporation, Redmond, Wash., and Lightweight Directory Access Protocol (LDAP), which is available in an open source implementation at www.openldap.org, for example. A database check directory of authorized users of the network 54 may also be checked. The host 52 is also preferably evaluated to ensure that it is free of software vulnerabilities and infections, such as viruses and worms, for example, and copyright violations, for example. The gateway server 60 can check for signatures of specific know viruses and worms, as is known in the art. The use of plug-ins dedicated to each authentication technique facilitates the implementation of one or more authentication and evaluation techniques, or changes in such techniques.

At step 74, usage information pertaining to the user's and/or host's usage of network resources is collected from one or more processors within the network 54. The usage information may include conditions provided by the servers 62, 64, 66, 68 controlling network resources, as well as sources of information, such as the class schedule database 69. At step 76, the usage information is aggregated to generate a set of usage rules for the user 56 and/or host 52. At step 78, the user 56 and/or host 52 is allowed to access and operate one or more network resources in accordance with the usage rules. The gateway server 60, for example, may collect and aggregate the information from the servers 62, 64, 66, 68 within the system 50 to establish the set of usage rules for the entity 56 based on the aggregated information. The gateway server 60 then allows access to the user 56 and/or host 52 and allows them to operate network resources, based on the set of usage rules. The conditions and information are preferably collected and aggregated by plug-ins.

FIG. 2B is a flow chart of a more detailed example of a method in accordance with this embodiment. Suppose, for example, that a user, such as a university student, attempts to log onto the network 50 via the host 52 at 1:00 PM on a Monday afternoon. Using a standard logon procedure, the gateway server 60 prompts the student to provide a user ID and a password. The gateway server 60 also queries the host 52 for a host identifier, such as a MAC address. After the identification data is received from the user and the host ID data is received in step 80. The user 56 and/or the host 52 are authenticated, preferably as discussed above with respect to FIG. 2A, in step 81.

The gateway server 60 transmits the student's user ID and the host ID data to various servers within the system 50, for example to the Internet server 64, the email server 62, the library server 66, and to the class schedule database 69, in step 82. Upon receiving the student ID, the respective server responds by transmitting information pertaining to the particular user 56 and host 52. In this example, at least one server provides access information comprising one or more conditions.

For example, the Internet server 64 may inform the gateway server 925 that the particular user is generally authorized to access the Internet at any time except on Jun. 2, YYYY between 9:00 AM and 11:00 AM. The user may not be authorized to access the Internet during this period because the user has a scheduled examination during those hours, for example. The Internet server 64 additionally informs the gateway server 60 that the computers in the library, including host 52, are restricted from accessing the Internet at all times. The email server 62 may notify the gateway server 60 that the user in question has access to the user's university email accounts, except on Mondays and Wednesdays between 2:00 PM and 4:00 PM. In this example. The class schedule database 69 informs the gateway server 60 that that the user 58 has a scheduled history class on Mondays and Wednesdays between 2:00 PM and 4:00 PM. The class schedule database 69 may also provide the information that the professor of the class requires that students' email access be denied during the class. The email server 62 also informs the gateway server 60 that university email accounts may be accessed from the host 52. In addition, the library server 66 informs the gateway server 60 that the user 56 has unrestricted access to the university's online library resources; however, the host 52 is allowed to download textual material only, and is restricted from downloading any video materials.

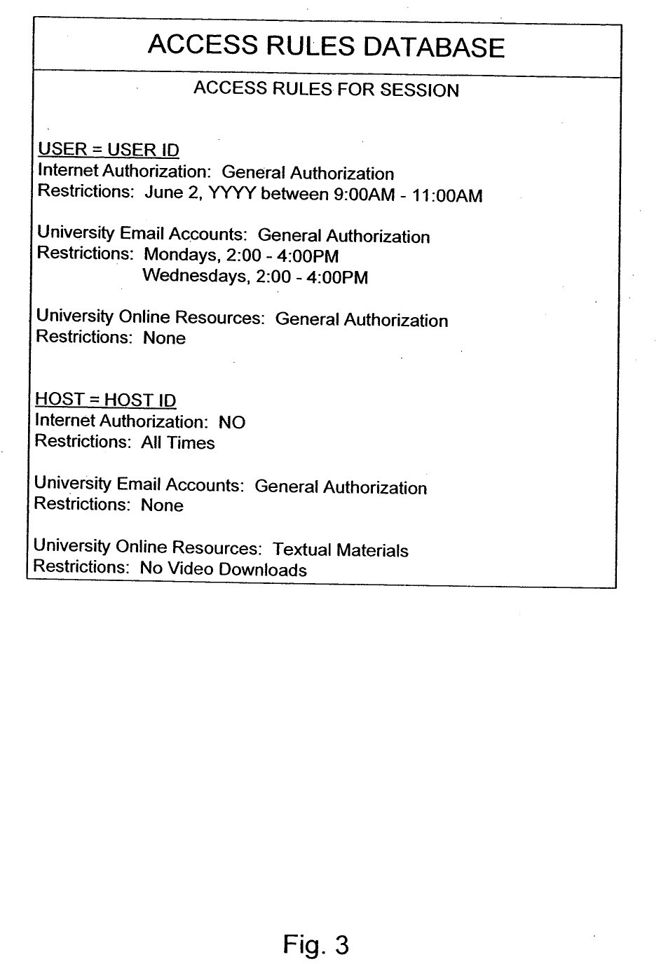

At step 84, the gateway server 60 receives from each respective server on the network 54 the access and operation information pertaining to the user and the host 52, and at step 86 aggregates the access and operation information received from the servers to create a set of usage rules for the user and for the host 52 during the current session. An example of an aggregated set of usage rules 87 is shown in FIG. 3. The usage rules 87 may be stored by the gateway server 60, for example, in a database maintained in memory. Referring to the access rules database 87, the particular user 56 is allowed to access the Internet at any time except on Jun. 2, YYYY between 9:00 AM and 11:00 AM. The user 56 has general access to the user's email accounts, except on Mondays between 2:00 PM and 4:00 PM, and on Wednesdays between 2:00 PM and 4:00 PM, and has unrestricted access to the university's online library resources. The host 52, which in this example is a library computer, is restricted from accessing the Internet, is authorized to access university email accounts, and is restricted from downloading any video materials.

At step 88, the gateway server 60 receives from the user 56 a request to access a network resource. For example, the user may attempt to access the library server 66 for the purpose of browsing the library's online card catalog to find books discussing third-century Chinese history. The resource, such as the email server 62, may require a separate login and authentications, as well.

At step 90, the gateway server 60 applies the set of usage rules to the user's network access request to determine one or more current usage rights for the user and for the host 52. In the illustrative example, since it is 1:00 PM on Monday, the gateway server 60 determines that both the user 56 and the host 52 have the right to access the library's online card catalog. At step 92, the gateway server 60 allows the user to access the network 54 in accordance with the user's current usage rights and grants the user access to the library's card catalog.

When a user accesses the network 54 via a particular host device, a “session” begins. The session continues until the user's connection to the network via the particular host is terminated. The gateway server 60 continues to monitor a user's activity during the course of a session and also regularly monitors the set of usage rules associated with the user and client. If the set of usage rules changes or a previously unmet condition is met (due to the passage of time, for example), the gateway server 60 updates the user's rights accordingly. The gateway server 60 then notifies the user 56 of the forbidden operation.

After gaining access, the user 56 may attempt an operation on a network resource, such as checking email or accessing the Internet. The gateway server 60 receives a request to perform the operation, in step 94. For example, the user may identify a relevant textual material in the online card catalog, and try to download it. The user will be allowed to perform the operation, in accordance with the current usage rights, in step 98. For example, the gateway server 60 checks the usage rights based on the usage rules 87 and finds that the user 56 may download textual material. If the user 56 had attempted to download video material, however that would not be allowed.

Then, at 1:30 PM, the user 56 attempts to access an email account maintained by the email server 62. The gateway server 60 receives a request to access the university email accounts from the user and again examines the set of usage rules stored in database 87, in step 88. The gateway server 60 determines that the user 56 has general access to the user's email accounts, but does not have access to the email accounts on Mondays between 2:00 PM and 4:00 PM or on Wednesdays between 2:00 PM and 4:00 PM, in step 90. Because the current date and time is 1:30 PM on a Monday, the gateway server 60 allows the user 56 to access the desired email account, in step 92.

In one embodiment of the invention, usage rules are periodically or continuously checked in step 90 to determine the entity's 58 current usage rights. For example, suppose now that the user 56 continues to use the university email account until 2:00 PM. During this period, the gateway server 60 monitors the user's activity and regularly re-examines the set of usage rules stored in database 87, in step 90. When the gateway server 60 determines that the time is 2:00 PM, the gateway server 60 determines that because the user is not authorized to the email accounts on Mondays between 2:00 PM and 4:00 PM, the user 56 may no longer access this resource. The gateway server 60 therefore terminates the user's access to the university email accounts and notifies the user 56 that access is denied between 2:00 PM and 4:00 PM.

The regular monitoring by the gateway server 60 of a user's set of usage rule also preferably allows a system administrator to dynamically, and in real-time, change and update a selected user's access rights. This is possible because the usage rules pertaining to a user are aggregated and stored together, as shown in FIG. 3. This is also facilitated by the use of plug-ins. Thus, for example, if the system administrator suspects suspicious online activity on the part of a particular student, the administrator can easily access the set of usage rules and specify that the student is no longer authorized to access a part, or all, of the network. The gateway server 60 immediately updates the students access rights and restricts the student's access to the network accordingly.

As mentioned above, “plug-ins” as used herein, are software modules that perform processing to achieve discrete goals, such as authentication, virus check, checking the current time, aggregating usage rules, and/or applying the aggregated rules, for example. In application of an example of a usage rule, a plug-in may check the user's class schedule, compare it to the current time, and deny or allow access to a particular network resource in accordance with the usage rule, for example. These plug-ins are preferably provided on the gateway 60. Plug-ins may be provided in other locations, as well. A plug-in may interact with any device coupled to the network 54 a server, a host, a personal computer, a database, or on another plug-in or other software application. A system administrator may easily connect one or more additional plug-ins to the network 50, or change plug-ins without the need for significant reconfiguration.

A plug-in may be “persistent” or “non-persistent.” A persistent plug-in is invoked periodically by the gateway server 60 at specified time intervals, while a user 56 and host 52 are coupled to the network 52. A non-persistent plug-in is only invoked upon the initial user logon. Certain evaluations, such as a virus check conducted on the host 52, are preferably conducted periodically by a persistent plug-in. In the example above, the plug-in comparing the current time to the user's schedule is preferably a persistent plug-in that periodically conducts the comparison while the user is on the network. That way, the access of a user to network resource may be terminated when a class starts, even though the user properly had access prior to the start of the class. Each persistent plug-in may be set to run at any desired frequency, such as every 15 minutes, hourly, or more or less frequently. On the other hand, the plug-in or plug-ins authenticating the user 56 based on the user's password, need only be checked on login and do not need to be persistent, for example. Plug-ins may run in sequence or in parallel.

In another example, the network resources may include equipment, such as exercise equipment or printers, for example. The gateway server 60 may receive usage rules from the relevant server, such as the gym server 68 for exercise equipment or a library server 66 for a printer in the library, for example. Suppose that one or more exercise machines, such as a treadmill 70 located in the university gymnasium, are connected to the network 50, either directly or through the gym server 68 shown in FIG. 1. When a user 56 wishes to use the exercise machine 70, the user may pass an identification card through a card reader attached to the machine. Identification information contained on the user's identification card is transmitted to the gateway server 60, either directly or through the gym server 68. The gateway server 60 is configured to receive the identification information and communicate with the gym server 68 to generate a set of usage rules, as described above. It may communicate with other servers, as well. The gym server 68 may indicate that the user is authorized to use the exercise machine 70 at any time of the day, except when the user is scheduled for class. Therefore, the gateway server 60 generates a set of access rules including a rule indicating that the user is authorized to use the exercise machine 908 at any time, except during a class. In the case of a library printer, the library server 66 may only enable the printing of downloaded material to the extent allowed by copyright laws.

In addition to the layer of access rules, the gym server 68 may provide additional rules relating to the operation of the exercise machine 70 by the user 56. For example, the gym server may store an exercise program prepared by gym staff for that user 56. The treadmill 70 may then be automatically set to run a particular exercise routine on the treadmill. That and other routines for other types of equipment may be included with the operational rules provided by the gym server 68 to the gateway server 60. The gateway server 60 could then cause the treadmill 70 to implement the routine or it could instruct the gym server 68 to cause the treadmill to implement the routine.

The gym server 68 may also store the user's health-related information, such as that the user has a heart condition and should not, therefore, operate the treadmill 70 at more than a particular speed. After the user 56 begins to use the exercise machine 70, the gateway server 60 and/or the gym server 68 continue to receive information from the exercise machine, including the machine's current speed. The gateway server 60 and/or the gym server 68 monitor the user's access rules and operational rules, and if an operational rule is violated, a warning may be issued, such as a flashing light. Alternatively, the acceleration of the treadmill 70 may be limited, or the operation of the treadmill 70 stopped, for example. The gateway server 60 may also obtain information from the healthcare server (not shown) of the university's healthcare facility, and based on that information, determine that the intensity of the user's workout should be limited.

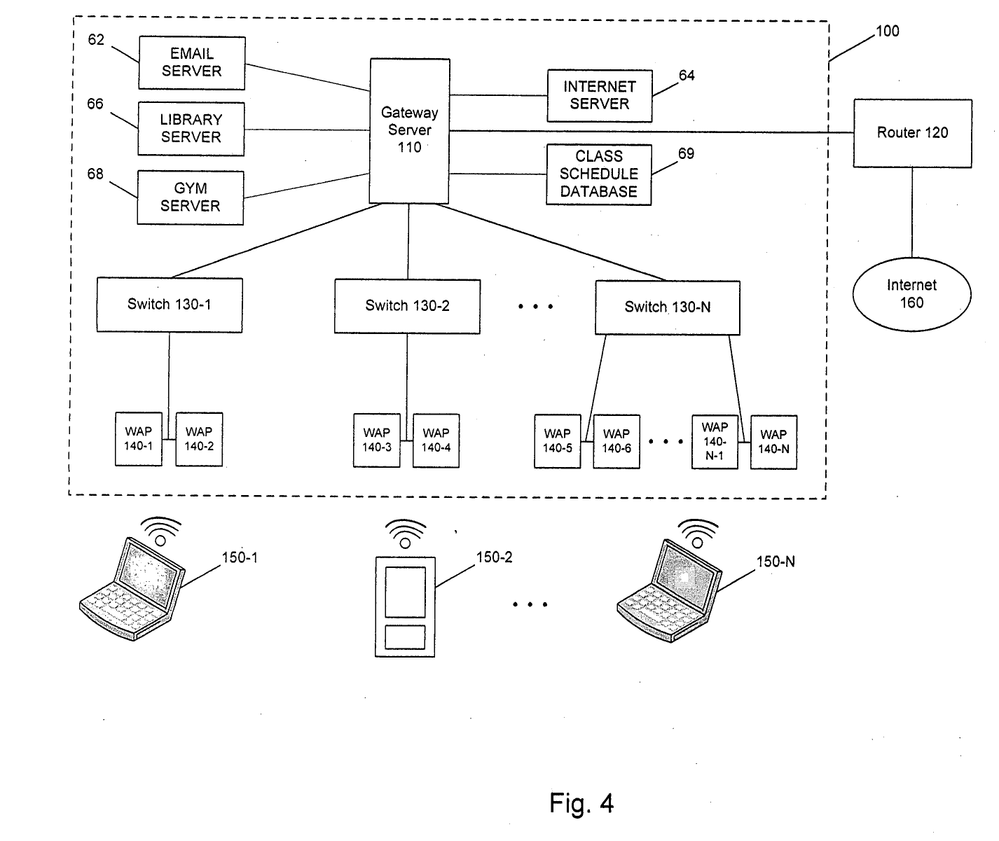

FIG. 4 is block diagram of another example of a system 100 embodying the principles of an embodiment of the invention for implementing dynamic rules which establish user connectivity, authentication and access protocols in connection with system 100. System 100 enables users—through their respective hardware devices, such as wireless devices 150-1 through 150-N (also referred to herein as “hosts”)—to access gateway server 110, as well as one or more networks that are in communication with a gateway server 110, such as the Internet 160, through a router 120. The email server 62, the Internet server 64, the library server 66, and the gym server 68 are also shown.

While only wireless devices 150-1 through 150-N are shown, the connectivity, authentication, and usage functionality described herein can also be incorporated in systems where hosts are connected to the system 100 by wired connections, or both wireless and wired connections.

The wireless devices 150-1 to 150-N (which may be a laptop computer 150-1, a personal digital assistant (PDA) 150-2, a desktop computer, a cell phone, a workstation (not shown), etc.) may communicate with the gateway server 110, via wireless access points (hereinafter “WAPs”) 140-1 to 140-N and switches 130-1 to 130-N. In the system 100, information is received upstream from a host, such as the host 150-1, via the WAP 140-1. The WAP 140-1 transmits the information to the switch 130-1, which in turn directs the information to gateway server 110. When communication is sent downstream in this example, the gateway server 110 sends information to the host 150-1 by transmitting the information to the switch 130-1, which is then transmitted to the WAP 140-1 and directed to the host 150-1. The data may be transmitted using the Transmission Control Protocol/Internet Protocol (TCP/IP), for example, including the User Datagram Protocol/Internet Protocol (“UDP/IP”) and Internet Control Message Protocol (“ICMP”), for example.

To attempt host connectivity with the system 100, the host device 150 should be within a specified range of WAP 140. For instance, using the Cisco Aironet 1231 WAP, the host 150 must be within approximately 90 meters of WAP 140—if the user and the WAP 140 are located indoors—or approximately 400 meters—if the host 150 and the WAP 140 are located outdoors. In addition, a browser should be open by the host 150.

The system 100 may comprise standard, off-the-shelf components. For example, the WAPs 140-1 to 140-N may comprise Cisco Aironet 1231 wireless access points and switches 130-1 to 130-N may comprise Cisco Catalyst 2950.

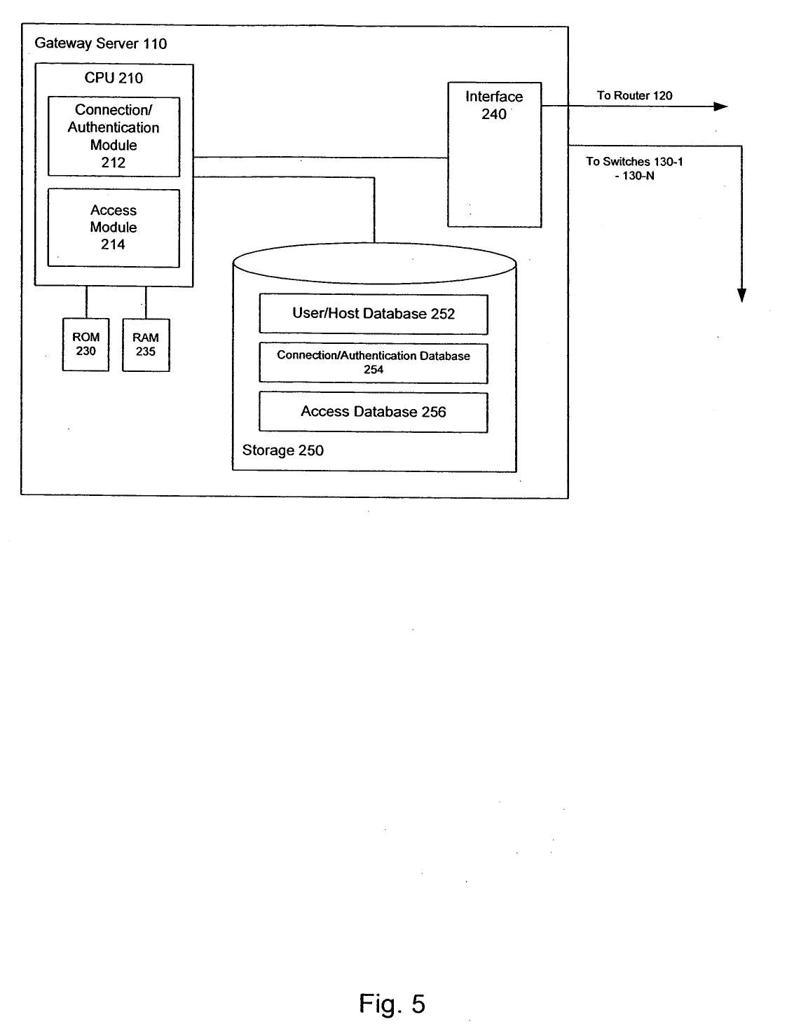

FIG. 5 is an example of a block diagram of a gateway server 110, which may include standard hardware components, such as a central processing unit (CPU) 210, a read only memory (ROM) 230, a random access memory (RAM) 235, an interface (I/F) 240, and storage 250. The CPU 210 is preferably linked to each of ROM 230, RAM 235, I/F 240, and storage 250, either by means of a shared data bus, or dedicated connections. The CPU 210 may be embodied as a single commercially available processor or the CPU 210 may be embodied as a number of such processors operating in parallel.

The CPU 210 may be an Intel Pentium 4, operating at 3 gigahertz and running a Linux operating system, for example. In addition, RAM 235 preferably comprises at least 1 gigabyte of memory (2 or more gigabytes of memory is recommended), I/F 140 includes at least two connections (copper and/or fiber), and storage 250 preferably comprises 40 gigabytes or more of disk space.

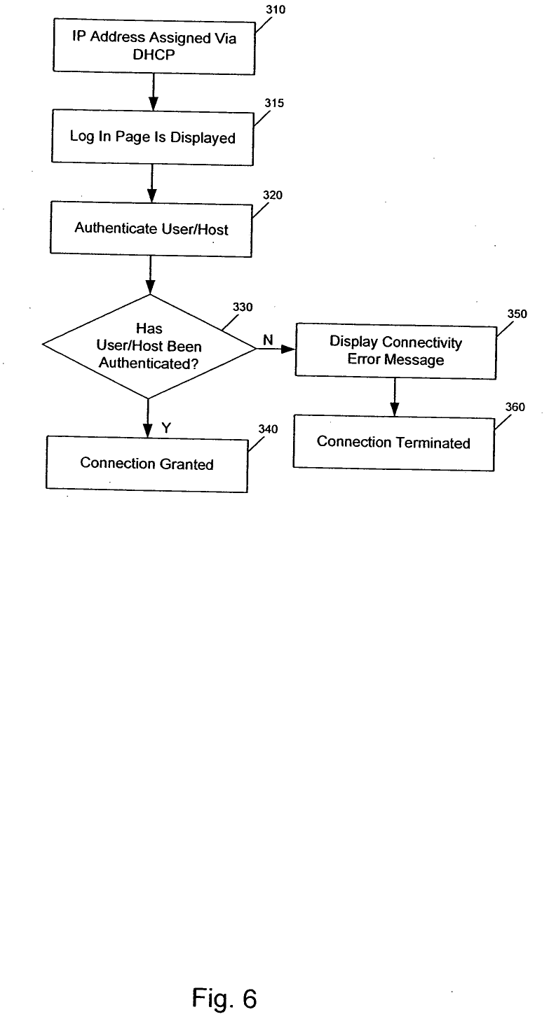

The ROM 230 is operable to store one or more instructions, discussed further below in conjunction with FIGS. 6 to 10, which the CPU 210 is operable to retrieve, interpret and execute. For example, the ROM 230 preferably stores processes for enabling hosts to connect to system 100, for accessing resources managed by system 100 pursuant to established security and institution rules, and for terminating connectivity to system 100.

The CPU 210 preferably includes a control unit, an arithmetic logic unit (ALU), and a CPU local memory storage device, such as, for example, a stackable cache or a plurality of registers, in a known manner. These components, which are known in the art, are not shown in FIG. 5. The control unit is operable to retrieve instructions from the ROM 230. The ALU is operable to perform a plurality of operations needed to carry out the instructions. The CPU local memory storage device is operable to provide high-speed storage used for storing temporary results and control information.

The I/F 240 connects the gateway server 110 to, in this example, switches 130-1 to 130-N and the router 120. Additional routers for communicating with hosts and additional networks may be accessible to the gateway server 110 via the interface 240. Such connection may be by means of a TCP/IP connection using a wide area network, for example.

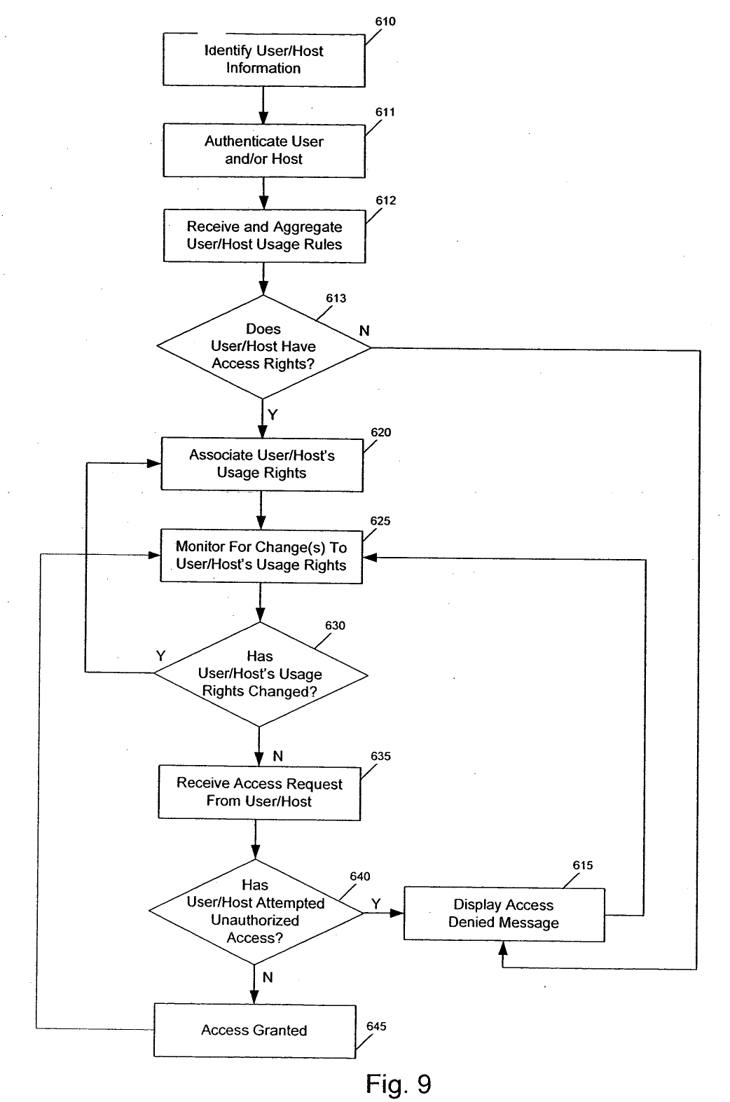

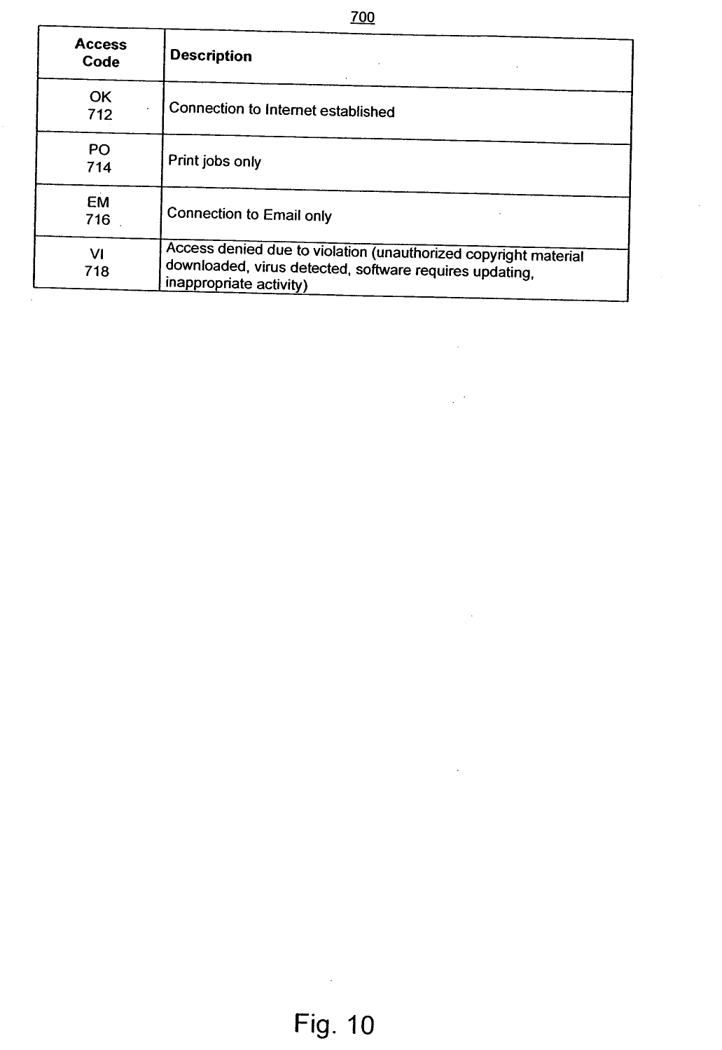

The CPU 210 may handle user connection and authentication (as described in detail below with reference to FIGS. 6 to 8) and user access to network resources (as described in detail below with reference to FIGS. 9 and 10), and these CPU capabilities are functionally illustrated in FIG. 5 as connection/authentication module 212 and access module 214. The storage 250 stores data for access by CPU 210 to, among other things, effectuate host connection, authorization and access. The storage 250 may comprise several databases, including a host database 252, a connection/authentication database 254, and an access database 254.

The host/user database 252 includes information relating to hosts and users. This information may include at least some or all of the following for each user and/or host: registered user's names, user login ID associated with each registered user name, password associated with the user login ID, a media access control (MAC) address associated with the host assigned to the user name and/or user ID, the user's status (e.g., employee, manager, owner, student, faculty, system administrator, etc.), and the like.

A connection/authentication database 254 stores rules for host connection to the system 100 and authenticating a host and/or user attempting to connect to the system 100. These rules are described below in connection with FIGS. 6 to 8. In addition, access database 256 stores rules for host access to resources provided by the system 100, which rules are described below in connection with FIGS. 9 and 10.

As described above, the system 100 may be situated in one of a variety of institutions, including schools, workplace offices, hotels, cafes, libraries, and the like. Successful connectivity and authentication, as well as resource access, is dependent on institution security rules, sometimes referred to as firewall rules, and institution business rules established by the institution implementing the system.

In order for a user to gain access to the system 100, the user must first attempt to connect with the system and then be authenticated. An example of a process of connecting and authenticating a host for system access is shown in the flowchart of FIG. 6.

Upon booting up a host, such as host 150-1, which is in communication with WAP 140-1, host 150-1 is assigned an Internet Protocol (IP) address via the Dynamic Host Configuration Protocol (DHCP) in the form of, for example, 10.100.x.x (Netmask 255.255.0.0) (step 310). Preferably, private IP addresses are used, thereby precluding the need to request additional subnets, enabling accommodation of more than 254 users, allowing all IP addresses on the same gateway server (such as the gateway server 110) to be on the same subnet (which facilitates roaming and troubleshooting), and protecting hosts from hacking initiated by those outside of the system 100.

By being in communication with the WAP 140-1 and accessing a browser, in this example, a login page is automatically displayed on host 150-1 (step 315). In one instance, all host activity that requires a network connection—besides access to the login page—is disabled (including Internet browsing, email, instant messaging, peer-to-peer communications, etc.).

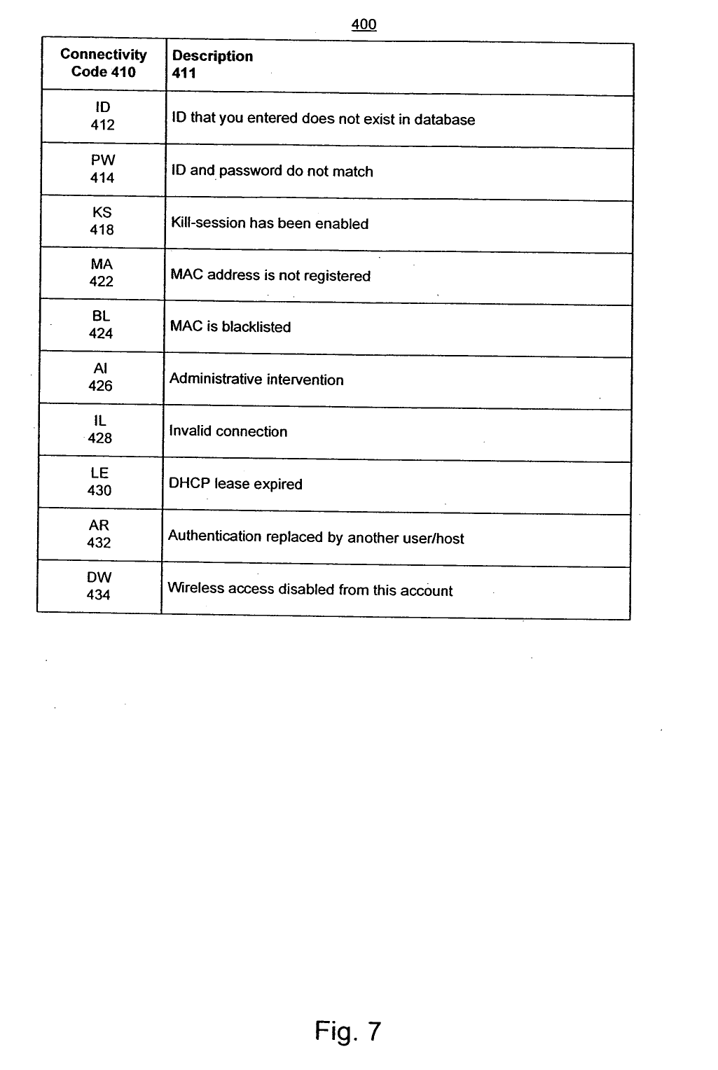

The login page provides a dialog box to a host in which a user is requested to enter a user login ID and associated password, so that the user and/or host can be authenticated (step 320). In one example, a host is authenticated when connection/authentication module 212 determines that the user login ID and associated password provided by a user match a preexisting user login ID and associated password stored in host/user database 252. In another example, after module 212 determines that the user-provided login ID and password match a preexisting data pair stored in database 252, the host MAC address may be requested by the CPU 210 to determine whether host connectivity should be maintained or terminated. If user/host authentication is successful (step 330), the connection is maintained (step 340). If, however, user/host authentication is unsuccessful, a connectivity error message is displayed by the host 150 (step 350) and the connection is terminated (step 360). Authentication failure may have various causes. A representative listing of such causes is provided by table 400 of FIG. 7.

Connectivity codes 410 and associated connectivity messages 411 may be stored in connection/authentication database 252 to inform users of connectivity/authentication failures. For example, if a user tries to log in to the system 100 and enters a user login ID that is not stored by user/host database 252, the ID connectivity code 412 is accessed and a message is displayed to the user indicating that the entered ID does not exist in the network database. If the user login ID and password received from a user do not match, the PW connectivity code 414 is accessed and a message is displayed on the host 150 indicating that the ID and password do not match.

In some circumstances, a specific user or a given set of users may be restricted from maintaining a connection with the system 100 for a given period of time, such as while a certain condition exists. For example, as discussed above, a university may configure its network such that if a user attempts to log in to system 100 while the student is scheduled to be in class, the student's authentication is denied and connectivity is terminated; in a corporate office, the system 100 may be configured such that employees cannot access their office computer network when they are scheduled to attend a mandatory meeting. Refusing network connectivity for a given set of users for a certain period of time, while a predetermined condition exists, may trigger a KS (kill-session) connectivity code 418, for example, and generate a message to the affected user(s) that the kill-session mechanism has been enabled.

In another example, connectivity may be denied when a host's MAC address is not stored by user/host database 252. In such instance, the MA connectivity code 422 is accessed and the user is informed that system connectivity has been denied because the host's MAC address is not registered with the system 100.

In another example, authentication fails when a user/host attempts connection and authentication, where the host MAC address is deemed blacklisted. A host may be blacklisted for a number of reasons, including: the host has been infected with a virus, the host has been involved in activities that are a violation of copyright laws, the host does not have appropriate hardware or software requirements, or the host has been involved in some inappropriate activity, such as accessing pornographic materials, for example. In such a case, the host may be blacklisted from connecting to system 100 until a system administrator determines that the problem has been satisfactorily addressed and the user's host MAC address is no longer considered in bad standing. When a host attempts authentication and the host MAC address is blacklisted, BL connectivity code 424 is accessed and the user is informed that the MAC has been blacklisted.

While a user is accessing the system 100, the user's host may be monitored to ensure that the host is not infected with a virus, that the user is not downloading unauthorized content, that the host has the appropriate system (hardware and/or software) requirements, and that the user is not using the host or system 100 for inappropriate purposes. A combination of commonly available intrusion detection software, such as Snort 2.0, for example, and customized scanning software may be used to scan hosts for inappropriate, incorrect or anomalous activity, such as copyright violations and viruses or worms existing on host(s). The system 100 may be configured to provide to hosts software patches and upgrades. These patches and upgrades may be made available on a host by host basis, as conditions require, or may be made available to all hosts accessing the system 100. In addition, some of these downloads may be required in order for a host to establish or maintain connectivity, whereas other downloads may be optional. The gateway server 110 is configured to send messages to the hosts 150 regarding the availability of these downloads and whether they are required or not.

If one or more of these conditions are detected, connectivity may be terminated by the gateway 110. This may be accomplished by accessing the AI connectivity code 426 and informing the user that the system administrator has terminated the user's and/or host's connection, for example.

In another instance, the connection/authentication module 212 may determine that the connection between the host 150 and system 100 is invalid—i.e., that the host has obtained an IP address but has not yet been authenticated. In such a case, IL connectivity code 428 is accessed and the user is informed that the connection is not maintained due to the invalid connection. In addition, the amount of time that a given host has accessed an IP address lease may have met a predetermined maximum time limit, causing the IP address lease to expire. In such a circumstance, the LE connectivity code 430 is accessed and the host displays a message that the lease has expired and that system connectivity is being terminated.

Simultaneous login (enabling the same user to log in from multiple hosts at the same time) may be permitted or disallowed. When disallowed, a simultaneous login may affect connectivity in one of two ways: (1) the latter authentication request by the second host is denied, while connectivity by the first host remains intact, or (2) the latter authentication request by the second host is granted, while connectivity by the first host is terminated. In either event, AR connectivity code 432 is accessed, which enables the host whose connectivity is to be terminated to display a message that authentication is being replaced by another host.

In another circumstance, wireless access for a given user may be completely disabled. In such a circumstance, the user is not allowed to access the network from any device, the DW connectivity code 434 is accessed, and the user is informed that the account had been disabled.

Thus, as described above, system connectivity may be disabled in several different manners, including, without limitation: (1) temporary disabling user/host access (implementing a kill-session while a student user has a class scheduled or an employee has a meeting scheduled, for example); (2) blacklisting a user, thereby precluding system connectivity by the user (if the user is accessing system 100 to engage in inappropriate activity, such as downloading unauthorized or pornographic materials, for example); and/or (3) blacklisting a host, thereby precluding system connectivity by the host (if host 150 has a virus, for example).

In addition, as also described above, connection disablement may occur during authentication (see steps 330 and 350 of FIG. 6) or may occur after a user has been authenticated by and has access to the system 100. The latter may occur when administrative intervention is initiated, a kill-session has been summoned (while a user is accessing system 100), the DHCP lease(s) for one or more users have expired, the same user has impermissibly logged into two hosts simultaneously, or wireless access becomes disabled, for example.

An applet may be downloaded to the host's accessing system 100 which allows a host to display status lights to indicate whether a user/host has successfully connected to the system 100. For example, a green, yellow, or red light may be displayed to indicate connectivity status. A green light may indicate that the user/host has been successfully authenticated by system 100 and can access system resources, a yellow light may indicate that an IP address was successfully obtained by the host, but that the user/host has not yet authenticated and needs to do so in order to access system resources, and a red light may indicate that no IP address has been obtained by the host and that there is a connectivity problem, such as host adapter problem, incorrect host configuration, etc., for example.

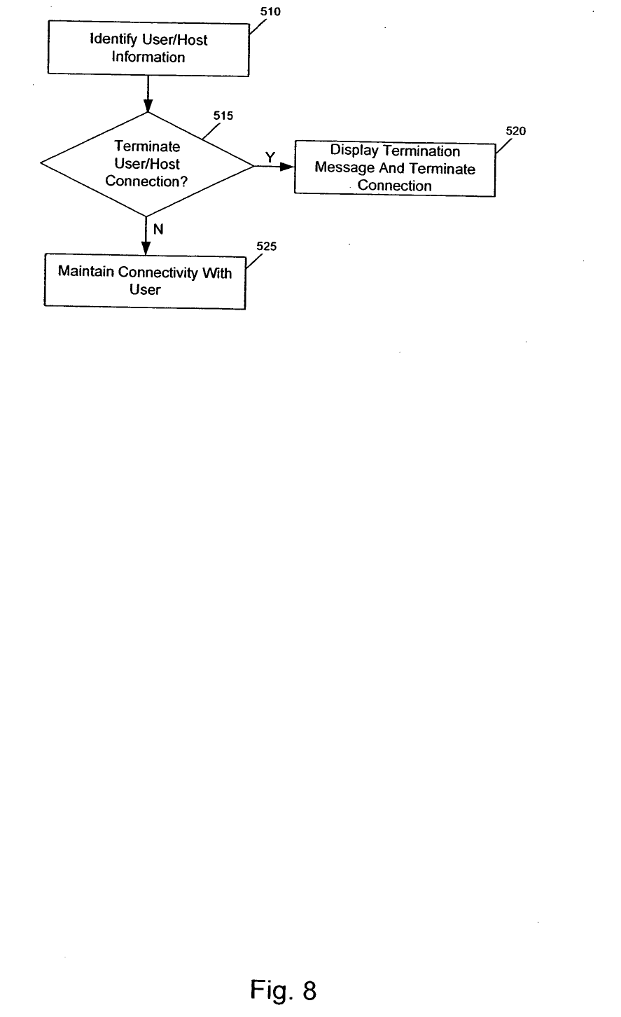

An example of a process for terminating user/host connectivity by the system 100, in particular by the gateway server 60 or 110, after authentication and access, is shown in the flowchart of FIG. 8. At step 510, the connection/authentication module 212 identifies the various hosts and users that are accessing system 100. In addition, the module 112 identifies connection/authentication rules stored by database 254, such as those conditions identified in table 400. For each user, the module 212 determines whether user/host connectivity should be terminated (step 515). If user and/or host connection is to be terminated, the relevant termination message (identified by table 400, for example) is displayed by the host 150 and the host connection is terminated (step 520). If, however, no instruction to terminate the connection is issued by connection/authentication module 212, then user/host connectivity is maintained (step 525).

While the host 150 is connected to the system 100, the gateway server 110, enables a particular user to access some or all of the networking resources available to the system 100, via access module 214 of CPU 210. For example, in one instance, the system 100 is in communication with Internet 160, with output devices (which are not shown), such as printers, and with certain software applications (such as Lotus Notes). Institution rules may be stored by the access database 256 for determining which of these system resources are to be made available to specific users/hosts or groups of users/hosts.

For example, suppose the system 100 is located and provided by a corporate office and hosts 150-1 to 150-N are employees at the corporate office. In such a circumstance, the gateway 110 may be configured such that, in general, all employees typically have access to most system resources. As discussed above, however, suppose on the first Monday of each month, a mandatory meeting is scheduled for the corporate sales force during the hours of 9:00 a.m. to 1:00 p.m. In this instance, it may desirable, for this time period only, to terminate Internet and Lotus Notes access to the sales force, to encourage meeting attendance, but to maintain, for example, printer access in case an employee needs to print materials for the meeting. In addition, it may be desirable to restrict Internet access of those employees who have been downloading unauthorized or inappropriate materials from the Internet, or to those employees whose computers do not have the most up to date browser software and/or virus protection software. Finally, it may be desirable to terminate any system connectivity to the host(s) that are infected with one or more viruses. By storing the conditions for restricting user/host access in access database 256, storing conditions for completely terminating user/host activity in connection/authorization database 254 and storing user/host information in user/host database 252, CPU 210 is capable of determining connection and access policies for each user and of implementing the appropriate connections and access pursuant to such policies.

The system 100 may be used in other environments, including military bases, government offices, and financial institutions, for example. Implementing system 100 at a state's Department of Motor Vehicles (DMV) office, for example, may enable users to access one or more networks at that office. The system may be established such that DMV employees have access to all system resources (the Internet, software applications, printing, etc.) and visitors (non-DMV employees) that log in to system 100 have access to the Internet only. In addition, the system may be further configured such that those visitors that are accessing the Internet to view the DMV's website will have full access, whereas those visitors who are accessing the Internet for other purposes have limited bandwidth for surfing the Internet.

In a military base, for example, a user's rank may determine whether connectivity should be enabled and the scope of access to the information provided on different databases. At a financial institution, visitors may be granted unlimited Internet access to approved sites (securities, banking and investment-related websites, for example) during market hours, and unlimited Internet access after market hours (since Internet traffic at the institution is typically lower after market hours). Analysts may have full access to their respective department's research information, while analysts for other departments may have limited or no access.

FIG. 9 is an example of a flowchart for determining and implementing user/host access for a given user/host that has connected to and has been authenticated by the system 100, in accordance with an embodiment of the invention. At step 610, the access module 214 identifies a user/host that has accessed system 100, such as a user of host 150-1. This is accomplished by identifying the user login ID provided by the user of host 150-1 and/or the MAC address provided by the host 150-1. At step 611, the user and/or the host are authenticated, preferably, as discussed above. At step 612, the access module 214 receives and aggregates one or more usage rules pertaining to the user and/or host. This may be accomplished in the manner described above, for example, by communicating with various servers within system 100. The usage rules may be stored in access rules database 256, for example.

Next, the access module 214 determines whether a user/host has any usage rights (step 613). If access module 214 determines, at this point, that the user/host has no access rights, then an access-denied message is displayed (step 615) and the user/host's session is terminated. If, however, the access module 214 determines that the user/host has access rights, these rights are identified and are associated with the user/host (step 620). Determining whether a user/host has access rights, and if so, the scope of such rights, is effectuated by accessing the access rules or policies stored in access database 256 and determining which of these policies apply to the user based upon the user's identification and status (for example, owner, faculty, etc.) associated with the user's login ID and/or the MAC address of host 150-1. The access module 214 of CPU 210 continues to monitor the databases 252 and 256 to determine whether any changes occur to the user or host's access rights (steps 625 and 630). In the course of monitoring for user/host access rights, the access module 214 may be configured to monitor a clock for time information for instances in which access rights are temporal in nature (no Internet access on Mondays, between 9:00 a.m. and 1:00 p.m., for example) or to monitor other databases (not shown), some of which may be external to gateway server 110 (such as students' class schedules, school calendar information, employer's holiday schedule, etc.).

If the access module 214 determines that one or more of the user/host's access rights have changed, the latest user/host access rights are updated and identified by the access module 214 at step 620. Otherwise, the system 100 is ready to receive access requests from the user/host at step 635 for particular network resources, such as the Internet server 64 or the email server 62, for example. Next, at step 640, access module 214 monitors the user/host's activity to determine whether unauthorized access is attempted. If the access requested by a user/host is not deemed unauthorized, access is granted, at step 645, and access module 214 continues to monitor for changes to user/host access rights, in step 625. A user may be notified of authorized access by displaying certain messages provided by a table 700, for example. A user may be informed that the host has established connection to the Internet (OK access code 712), that the host can only access the system printers (PO access code 714) or that only connection with the system's email is permitted (EM access code 716), for example.

If, however, at step 640, the user/host attempts to request an unauthorized access, an error message is displayed, at step 615, and access module 214 continues to monitor for changes to the user/host's access rights. A representative error message is provided in table 700. For example, a host may display an error message indicating that access is denied due to activity violation (VI access code 718) resulting from unauthorized downloading of copyrighted materials, a virus detected on the host, required update to host software, etc. Monitoring for access changes may continue until the session is terminated by the user or system 100.

It should be noted that system configuration and functionality may be modified and such modifications are typically managed by system administrators that access the system 100. System changes are typically accomplished by authenticated administrators that access system 100 through the World Wide Web. These administrators may view and change system configurations, view and disconnect some or all current host connections, view all available logs (for example, connections, configuration changes, triggered actions, etc.), and the like.

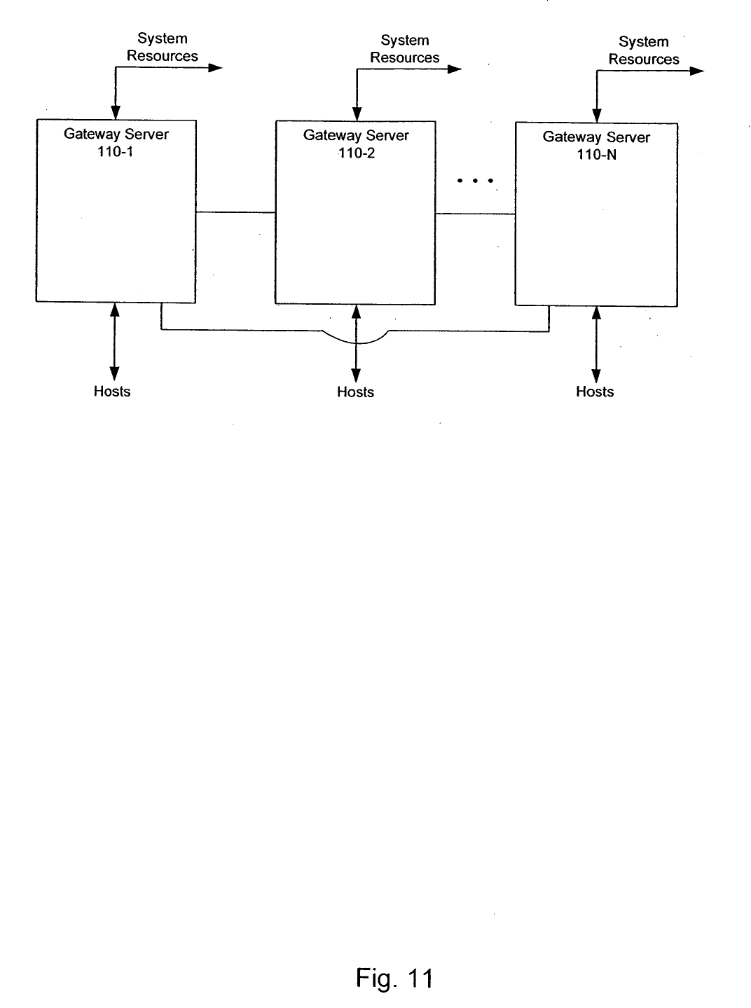

In addition, the number of WAPs, switches and gateways used by system 100 may vary and those shown in FIG. 4 are for illustration purposes only. For example, multiple gateway servers (having their dedicated or shared routers, switches, and WAPs) may be used. FIG. 11 illustrates multiple gateway servers 110-1 to 110-N communicating with one another for supporting access between gateway servers and hosts, gateway servers and system resources, and hosts and system resources. By implementing such an architecture, one gateway server can back-up another should one of the servers fail. In addition, system resources, such as stored information, networks and hardware resources, accessible to one gateway, and hosts connected to that gateway, can be accessed by the other gateways and hosts associated thereto.

It should also be noted that, although the process for logging in registered users has been described above, accommodations for guest accounts may also be established. A guest account may be established by a user after receiving an IP address and providing certain identifying information about the user and/or the user's host equipment.

In addition, the software for effectuating the connection, authentication, and access functionalities described above is preferably modular in nature, thereby facilitating integration of further features, such as one-time passwords with electronic keys, biometric authentication, etc.

Subnetworks may also be established where connection, authentication and/or access policies vary from one subnetwork to the other. This may be accomplished through, for example, the provision of software operable by CPU 210 and/or by using multiple gateways in a given environment.

Moreover, the rules/policies and related software for effectuating the connection, authentication, and access functionalities described above may be stored on a compact disc, DVD, or the like by, for example, using a compressed file system, which is loaded to the gateway memory upon boot up. For example, some or all of the information stored by the databases 252, 254 and 256 and/or instructions used by connection/authentication module 212 and access module 214 may be stored on these or some other portable media. Such a feature provides gateway server 110 with increased flexibility and security.

One of ordinary skill in the art will recognize that changes may be made to the embodiments described herein without departing from the spirit and scope of the invention, which is defined by the claims, below.

We claim:

1. A method, to control usage of resources on a network, comprising:
receiving from an entity identification information;
transmitting the identification information to a plurality of processors in a network;
receiving from at least some of the plurality of processors usage information pertaining to the entity, the usage information comprising at least one condition;
aggregating the received usage information to generate a set of usage rules; and
allowing the entity to use the network in accordance with the one or more usage rules.

2. The method of claim 1, further comprising:
executing at least one plug-in to determine whether to allow the entity to use the network in accordance with the one or more usage rules.

3. The method of claim 1, wherein the entity comprises either or both of a user and a host device.

4. The method of claim 1, wherein the entity comprises a user and a host device, the method further comprising:
authenticating the user; and
evaluating the host device.

5. The method of claim 3, wherein:
the network comprises a local area network (“LAN”) administered by a university or a corporation.

6. The method of claim 1, wherein the usage rules comprise access rules for access to a respective processor, the method comprising:
allowing the user to access the network in accordance with the access rules.

7. The method of claim 6, wherein the access rules indicate that the entity is authorized to access a specified network resource except during at least one specified time period.

8. The method of claim 6, wherein the at least one condition comprises a restriction on access to one or more network resources in accordance with a schedule.

9. The method of claim 1, further comprising:
updating the set of usage rules while the entity has access to the network; and
determining whether the entity can continue to use the network in accordance with the updated usage rules.

10. The method of claim 1, further comprising:
monitoring the set of usage rules while the entity has access to the network; and
determining whether the entity can continue to use the network in accordance with the usage rules.

11. The method of claim 1, wherein the usage information comprises operation rules related to a network resource, the method comprising:
receiving an operation rule related to operation of a network resource by the entity; and
allowing the entity to use the network resource in accordance with the operation rules.

12. The method of claim 1, wherein at least some of the processors correspond to respective network resources.

13. A system to control use of a network, comprising:
a first processor;
a network; and
a plurality of second processors coupled to the network;
wherein the first processor is configured to:
receive from an entity identification information;
transmit the identification information to the plurality of second processors;
receive from at least some of the second processors usage information pertaining to the entity, the usage information comprising at least one condition;
aggregate the received usage information to generate a set of usage rules; and
allow the entity to use the network in accordance with the one or more usage rules.

14. The system of claim 13, wherein the first processor comprises at least one plug-in to determine whether to allow the entity to use the network in accordance with the usage rules.

15. The system of claim 13, wherein the first processor comprises at least one plug-in to aggregate the received usage information to generate the set of usage rules.

16. The system of claim 13, wherein:
the entity comprises a user and a host device; and
the first processor is further configured to
authenticate the user; and
evaluate the host device.

17. The system of claim 13, wherein:
the network comprises a local area network (“LAN”) administered by a university or a corporation.

18. The system of claim 13, wherein the usage rules comprise access rules to network resources.

19. The system of claim 18, wherein the usage rules indicate that the entity is authorized to access a specified network resource except during at least one specified time period.

20. The system of claim 13, wherein the first processor is further configured to:
update the set of access rules while the entity has access to the network; and
determine whether the entity can continue to use the network in accordance with the one or more updated usage rules.

21. The system of claim 13, wherein the first processor is further configured to:
monitor the set of usage rules while the entity has access to the network; and
determine whether the entity can continue to use the network in accordance with the usage rules.

22. The system of claim 18, wherein the access information comprises a restriction on access to one or more network resources in accordance with a schedule.

23. The system of claim 18, wherein the usage information comprises operation rules related to a network resource, wherein first processor is configured to:
receive an operation rule related to operation of a network resource by the entity; and
allow the entity to use the network resource in accordance with the operation rule.

24. The system of claim 13, wherein at least some of the plurality of second processor correspond to respective network resources.

25. A method to control usage of resources on a network by an entity comprising a user and a host device to couple the user to the network, the method comprising:
receiving identification information from the entity;
evaluating the identity of user;
evaluating the host device;
evaluating a status of at least one additional condition related to the user;
allowing the entity to use one or more network resources based, at least in part on the evaluations.

26. The method of claim 25, wherein:
evaluating the user comprises authenticating the user.

27. The method of claim 26, wherein authenticating the user comprises implementing a plurality of authentication procedures by a respective plurality of plug-ins.

28. The method of claim 25, wherein evaluating the host device comprises:
determining whether the host device is vulnerable or infected.

29. The method of claim 25, wherein evaluating the status comprises:
determining whether there is a temporal limitation on an activity of the user with respect to the network; and
determining the current time.

30. The method of claim 25, comprising:
evaluating the host device by at least one plug-in.

31. The method of claim 25, comprising:
evaluating the status by at least one plug-in.

32. The method of claim 25, comprising:
evaluating the user, evaluating the host device, evaluating the at least one additional condition, and allowing the entity to use the one or more network resources, by respective plug-ins.

33. The method of claim 25, further comprising:
changing at least one of the evaluations by changing at least one plug-in.

34. The method of claim 25, further comprising:
adding at least one evaluation by adding at least one plug-in.

35. The method of claim 25, comprising:
conducting at least one of the evaluations by a persistent plug-in.

36. The method of claim 25, further comprising:
aggregating a plurality of additional conditions from at least two respective network resources.

37. The method of claim 36, comprising:
aggregating the plurality of additional conditions by a plurality of plug-ins.

38. A system to control usage of resources on a network by an entity comprising a user and a host device to couple the user to the network, the system comprising:
a processor; and
a network;
wherein the processor is configured to:
evaluate the identity of the user;
evaluate the host device;
evaluate at least one additional condition related to the user; and
allow the user to use one or more network resources based, at least in part, on the evaluations.

39. The system of claim 38, wherein the processor is configured to evaluate the user by authenticating the user.

40. The system of claim 38, wherein the processor comprises at least one plug-in to authenticate the user.

39. The system of claim 38, wherein the processor is configured to evaluate the host device by determining whether the host device is infected.

40. The system of claim 39, wherein the processor comprises a plug-in to determine whether the host device is infected.

41. The system of claim 38, wherein the processor is configured to evaluate the status by:
determining whether there is a temporal limitation on an activity of the user with respect to the network; and
determining the current time.

42. The system of claim 38, wherein the processor further comprises at least one plug-in to evaluate the status by at least one plug-in.

43. The system of claim 38, wherein the processor further comprises at least one respective plug-in to:
evaluate the user, evaluate the host device, evaluate at least one additional condition, and allow the entity to use the one or more network resources.

44. The system of claim 38, wherein the processor further comprises a persistent plug-in to conduct at least one of the evaluations.

45. The system of claim 38, wherein the processor further comprises:
a plurality of plug-ins to aggregate a plurality of additional conditions from at least two network resources.
